(19) United States
(12) Patent Application Publication
(10) Pub. No.: US 2024/0422663 A1
(43) Pub. Date: Dec. 19, 2024

(54) SYSTEMS AND METHODS FOR RELAY SELECTION IN MILLIMETER WAVE NETWORKS

(71) Applicant: INDIAN INSTITUTE OF TECHNOLOGY - BOMBAY, Mumbai (IN)

(72) Inventors: Gaurav Sudhir KASBEKAR, Mumbai (IN); Tushar Suresh MURATKAR, Mumbai (IN); Santosh Kumar SINGH, Mumbai (IN)

(73) Assignee: INDIAN INSTITUTE OF TECHNOLOGY - BOMBAY, Mumbai (IN)

(21) Appl. No.: 18/409,469

(22) Filed: Jan. 10, 2024

(30) Foreign Application Priority Data
Jun. 13, 2023 (IN) 202321040358

(51) Int. Cl. H04W 48/20; H04B 17/336; H04B 17/391

(52) U.S. Cl. CPC H04W 48/20; H04B 17/336; H04B 17/3913

(57) ABSTRACT

Embodiments herein disclose systems and methods for relay selection in mmWave networks, wherein the relay is selected using a Q-learning based method and the selected relay can be used by a source for communication with a destination in each time slot. Embodiments herein disclose systems and methods for relay selection in mmWave networks, wherein there are multiple source-destination pairs, and a relay is assigned to each source-destination pair in each time slot using the Q-learning based method.

### TECHNICAL FIELD

Embodiments disclosed herein relate to wireless communication networks, and more particularly to selection of relays in millimeter wave networks.

### BACKGROUND

A huge increase in the demand for network capacity and reduced latency in wireless networks has been brought on by the phenomenal expansion of mobile applications. To meet this demand, networks use millimeter wave (mmWave) frequency bands in fifth generation (5G) and beyond 5G communications, which have a large amount of free bandwidth.

However, mmWave communication suffers from high propagation loss. Further, mmWave transmissions are directional and hence, can be susceptible to blockage. The use of relays can be a potential solution to the problems of high propagation loss and blockage. Direct communication from a source to a destination can be difficult, possibly due to the absence of a line-of-Sight (LOS) path because of blockages and/or since the distance between the source and the destination is large. Hence, the source needs to communicate with the destination with the help of one relay chosen from the set of all relays. In general, several relays may have to be selected, wherein the selected relays are located between sources and destinations of data traffic. Current relay selection solutions use the max-min Signal to Noise Ratio (SNR)-based relay selection strategy.

### OBJECTS

The principal object of embodiments herein is to disclose systems and methods for relay selection in mmWave networks, wherein the relay is selected using a Q-learning based method and the selected relay can be used by a source for communication with a destination in each time slot.

Another object of embodiments herein is to disclose systems and methods for relay selection in mmWave networks, wherein there are multiple source-destination pairs, and a relay is assigned to each source-destination pair in each time slot using the Q-learning based method.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 depicts a system, wherein the system comprises a source, a destination, and a plurality of relays, and the source, the destination and the plurality of relays operate at mmWave frequencies, according to embodiments as disclosed herein;

FIG. 2 is a flowchart depicting the method for selecting a relay using a Q-learning based relay selection method for a system, wherein the system comprises a source, a destination, and a plurality of relays, and the source, the destination and the plurality of relays operate at mmWave frequencies, according to embodiments as disclosed herein;

FIG. 3 depicts an example system, wherein the system comprises a plurality of source-destination pairs, and a plurality of relays, wherein the plurality of source-destination pairs and the plurality of relays operate at mmWave frequencies, according to embodiments as disclosed herein; and

FIGS. 4A and 4B are flowcharts depicting a method for assigning a relay to each source-destination pair using a Q-learning based relay selection method for a system, wherein the system comprises a plurality of source-destination pairs and a plurality of relays, and the plurality of source-destination pairs and the plurality of relays operate at mmWave frequencies, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

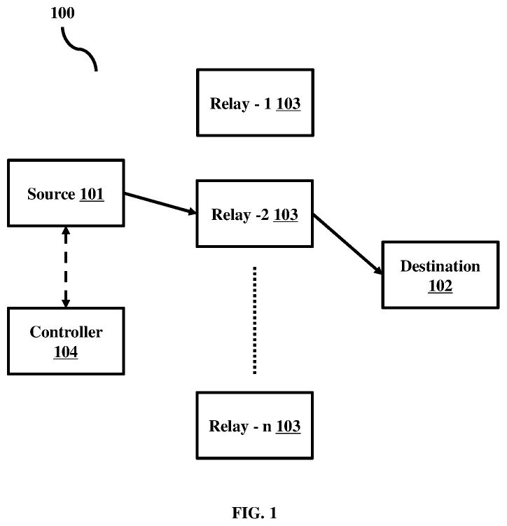

The embodiments herein achieve systems and methods for relay selection in mmWave networks. Referring now to the drawings, and more particularly to FIGS. 1 through 4B, where similar reference characters denote corresponding features consistently throughout the figures, there are shown embodiments.

Embodiments herein disclose systems and methods for relay selection in mmWave networks, wherein the relay is selected using a Q-learning based method and the selected relay can be used by a source for communication with a destination in each time slot.

Embodiments herein disclose systems and methods for relay selection in mmWave networks, wherein there are multiple source-destination pairs, and a relay is assigned to each source-destination pair in each time slot using the Q-learning based method.

Embodiments herein model the relay selection problem as a Markov Decision Process (MDP). The MDP comprises of the following entities: State, Action, Agent, Environment, and Reward. These entities are defined as follows:
1) State: The state is a vector consisting of the relay selected in the previous time slot along with the source-to-relay and relay-to-destination SNRs of all the relays in the current time slot.
2) Action: The action in a time slot is the relay selected in the time slot.
3) Agent: It represents the controller, which executes the algorithm and takes an action in each time slot.
4) Reward: The reward corresponding to a relay is defined as the throughput (data rate) at which communication can take place from the source to the destination via the relay minus the switching cost, where switching cost for a relay is the cost that would be incurred in switching from the relay selected in the previous time slot to that relay in the current time slot.
5) Environment: This is the proposed system model.

For solving the above MDP problem, embodiments herein use Q-learning, which is a type of reinforcement learning scheme. In this method, the agent stores a value (hereinafter referred to as Q-value), for each state-action pair in a database called the Q-table and updates the Q-values in every time slot. Q-values are real numbers, which are determined as follows: in time slot 0, the Q-value for every state-action pair is initialized to zero and in subsequent time slots, the Q-values are updated using equation (1). In time slot zero, embodiments herein initialize all the Q-values to zeros. In time slot t, the agent is in the current state sₜ. A number is selected uniformly at random between 0 and 1. If it is more than ϵ, then the relay with the highest Q-value

$$( i . e . , the relay ar {gmax}_{a} Q ( {s}_{t} , a ) )$$

is selected; otherwise, a random relay is selected, where ϵ∈(0, 1) is a small constant. Let aₜ denote the relay (action) selected in state sₜ. A reward rₜ is obtained and the agent transitions to the next state (sₜ₊₁). Based on the reward rₜ, the Q-value is updated using the following Bellman equation:

$${Q}^{new} ( {s}_{t} , {a}_{t} ) ← Q ( {s}_{t} , {a}_{t} ) + α ( {r}_{t} + γ \cdot {max Q}_{a} ( {s}_{t + 1} , a ) - Q ( {s}_{t} , {a}_{t} ) ) \qquad ( 1 )$$

where sₜ, aₜ and rₜ denote the state, action, and reward at time t, respectively. Also, α and γ represent the learning rate and discount factor respectively. The updated Q-values are then stored in the Q-table.

FIG. 1 depicts a system, wherein the system comprises a source, a destination, and a plurality of relays, and the source, the destination and the plurality of relays operate at mmWave frequencies. The system 100, as depicted comprises a source 101, a destination 102, a plurality of relays 103, and a controller 104. The source 101, the destination 102 and the plurality of relays 103 can use mmWave frequencies for communication among themselves. The source 101, the destination 102 and the plurality of relays 103 can be present at geographically separate locations. The source 101 can have a direct Line-of-Sight (LOS) path with at least one of the plurality of relays 103. At least one of the plurality of relays 103 can have a direct Line-of-Sight (LOS) path with the destination 102.

The controller 104 can communicate with the source 101, the destination 102 and the plurality of relays 103 using either a wired and/or wireless communications. Examples of the wired communications can be an optical fiber link, a Local Area Network (LAN), a Wide Area Network (WAN), or any suitable wired communication means. Examples of the wireless communications can be a cellular network, a mmWave network, and so on. In an embodiment herein, the controller 104 can be located in a separate device that communicates with the source 101. In an embodiment herein, the controller 104 can be located in the source 101. In an embodiment herein, the controller 104 can be located in the destination 102.

The controller 104 can divide the time into slots of equal duration. At the beginning of each slot, the source 101 can measure a first Signal-to-Noise Ratios (SNRs) of the links from the source 101 to each relay 103 and provide the measured first SNR to the controller 104. At the beginning of each slot, the source 101 can further measure a second Signal-to-Noise Ratios (SNRs) of the links from each relay 103 to the destination 102 and provide the measured second SNR to the controller 104. Communication from the source 101 to the relay 103 and from the relay 103 to the destination 102 takes place at a data rate (e.g., Shannon capacity) corresponding to the minimum of the first and second SNRs. Each SNR can be quantized into different quantization levels. The controller 104 can consider each time slot to be divided into two parts, wherein in a first part, the source 101 transmits to the selected relay 103 and in a second part, the selected relay 103 forwards the information received from the source 101 to the destination 102. At the beginning of each time slot, the controller 104 can select a relay 103 that the source 101 can use for communication with the destination 102 in that time slot.

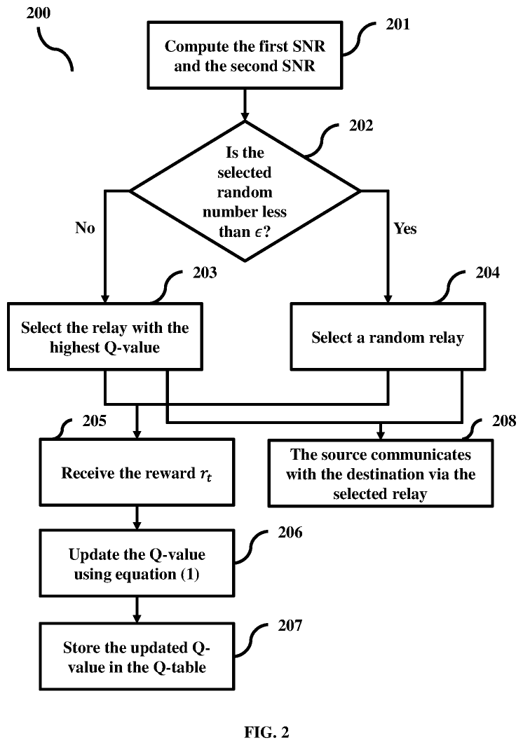

FIG. 2 is a flowchart depicting the method for selecting a relay using a Q-learning based relay selection method for a system, wherein the system comprises a source, a destination, and a plurality of relays, and the source, the destination and the plurality of relays operate at mmWave frequencies. In an embodiment herein, the Q-learning based relay selection method can be an epsilon greedy policy based Q-learning mechanism. Consider that the method 200 occurs in time slot t. Consider that the current state of the controller 104 is St. In step 201, the controller 104 computes the SNRs from the source 101 to each relay 103 (i.e., the first SNR) and from each relay 103 to the destination 102 (i.e., the second SNR). The SNR of each communication link may change with time due to mobility of the source, destination, relays and/or objects in the environment, and hence needs to be measured. The Q-values depend on the SNRs since rₜ in equation (1) depends on the SNRs. In step 202, the controller 104 checks if a randomly selected number is less than ϵ, where ϵ∈(0, 1) is a small constant and the randomly selected number can be uniformly selected between 0 and 1. If the randomly selected number is not less than ϵ, in step 203, the controller 104 selects the relay with the highest Q-value

$$( i . e . , the relay ar {gmax}_{a} Q ( {s}_{t} , a ) ) .$$

If the randomly selected number is less than ϵ, in step 204, the controller 104 selects a random relay. Let aₜ (action) denote the selected relay. In step 205, the controller 104 receives the reward rₜ. In step 206, the controller 104 updates the Q-value using the Bellman equation (i.e., equation (1)). In step 207, the controller 104 stores the updated Q-value in the Q-table. In step 208, the source 101 can communicate with the destination 102 via the selected relay 103. The various actions in method 200 may be performed in the order presented, in a different order or simultaneously. Further, in some embodiments, some actions listed in FIG. 2 may be omitted.

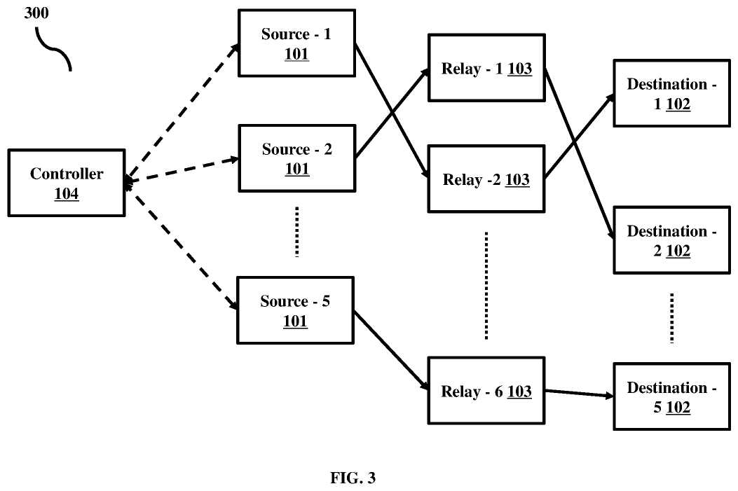

FIG. 3 depicts an example system, wherein the system comprises a plurality of source-destination pairs, and a plurality of relays, wherein the plurality of source-destination pairs and the plurality of relays operate at mmWave frequencies. The system 300, as depicted comprises a plurality of sources 101, a plurality of destinations 102, a plurality of relays 103, and a controller 104. The source 101, the destination 102 and the plurality of relays 103 can use mmWave frequencies for communication among themselves. The source 101, the destination 102 and the plurality of relays 103 can be present at geographically separate locations. The source 101 can have a direct Line-of-Sight (LOS) path with at least one of the plurality of relays 103. At least one of the plurality of relays 103 can have a direct Line-of-Sight (LOS) path with the destination 102.

The controller 104 can communicate with the source 101, the destination 102 and the plurality of relays 103 using either a wired and/or wireless communications. Examples of the wired communications can be an optical fiber link, a Local Area Network (LAN), a Wide Area Network (WAN), or any suitable wired communication means. Examples of the wireless communications can be a cellular network, a mmWave network, and so on. In an embodiment herein, the controller 104 can be located in a separate device that communicates with the source 101. In an embodiment herein, the controller 104 can be located in the source 101. In an embodiment herein, the controller 104 can be located in the destination 102.

The system 300 comprises of N source-destination pairs, where N is an integer and N≥1. In the example depicted in FIG. 3, N=5. The system 300 comprises of M relays, wherein M is an integer, M≥N and M≥1. In the example depicted in FIG. 3, M=6.

Embodiments herein consider a separate MDP for each source-destination pair with its state, action, agent, reward, and environment defined as for the MDP described for the single source-destination pair case (as disclosed herein). Also, the controller 104 maintains a separate Q-table for each source-destination pair. At time zero, the controller 104 initializes all the Q-values to zeros. In each subsequent time slot, the controller 104 updates the Q-values of each source-destination pair using the Bellman equation (i.e., equation (1)). Let i and k be the index for a source-destination pair and a relay, respectively. In each time slot, if the randomly selected number is less than ϵ, the controller 104 can assign relays to source-destination pairs randomly. In each time slot, if the randomly selected number is not less than ϵ, the controller 104 can use the procedure (as described below) to assign relays to source-destination pairs.

At the beginning of a time slot, the controller 104 considers the M×N Q-values corresponding to the current states of the N source-destination pairs and the M relays. Out of these M×N Q-values, the controller 104 selects the source-destination pair and relay with the highest Q-value. In case of a tie (i.e., two or more pairs of source-destination pair and relay have the highest Q-value), the controller 104 can select a source-destination pair and relay at random from the tied pairs of source-destination pairs and relays. Consider that this Q-value corresponds to source-destination pair i₁ and relay k₁. Then, the controller 104 assigns relay k₁ to source-destination pair i₁. Next, the controller 104 removes the source-destination pair i₁ and relay k₁, and all their corresponding Q-values from further consideration. As a result of this step, (M−1)×(N−1) Q-values remain. The controller 104 again selects the highest Q-value out of the above (M−1)×(N−1) Q-values. Suppose that this highest Q-value corresponds to source-destination pair i₂ and relay k₂. Then, the controller 104 assigns relay k₂ to source-destination pair i₂. The controller 104 continues in this manner until a relay has been assigned to every source-destination pair.

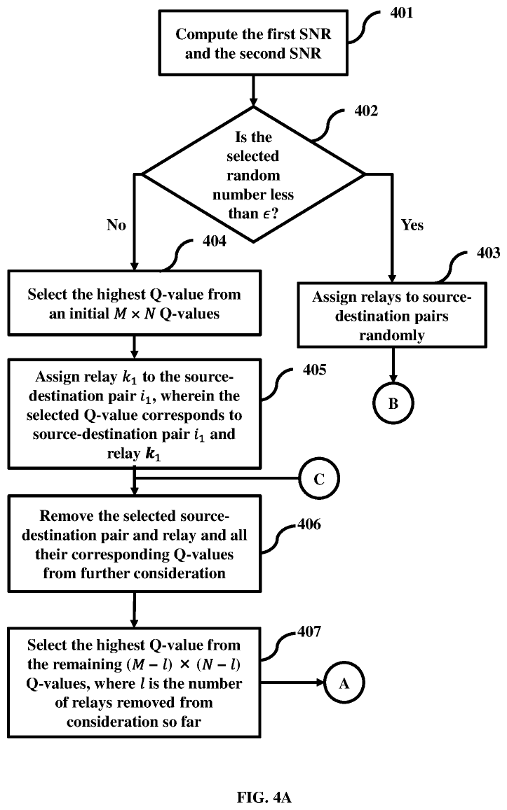

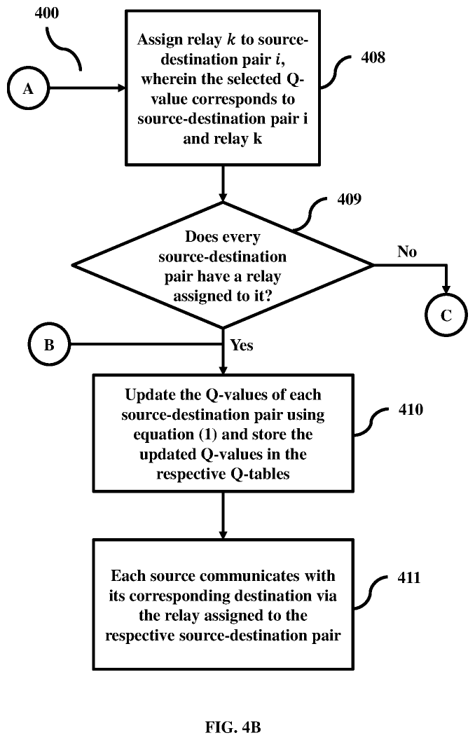

FIGS. 4A and 4B are flowcharts depicting a method for assigning a relay to each source-destination pair using a Q-learning based relay selection method for a system, wherein the system comprises a plurality of source-destination pairs and a plurality of relays, and the plurality of source-destination pairs and the plurality of relays operate at mmWave frequencies, according to embodiments as disclosed herein. Consider that the method 400 occurs in time slot t. Initially, there are M×N Q-values.

In step 401, the controller 104 computes the SNRs from each source to each relay and from each relay to each destination (i.e., the first SNR and the second SNR respectively). In step 402, the controller 104 checks if a randomly selected number is less than ϵ, where ϵ∈(0, 1) is a small constant and the randomly selected number can be uniformly selected between 0 and 1. If the randomly selected number is less than ϵ, in step 403, the controller 104 assigns relays to source-destination pairs randomly. If the randomly selected number is not less than ϵ, in step 404, the controller 104 selects the highest Q-value from M×N Q-values, wherein there are M×N Q-values, initially. If the selected Q-value corresponds to source-destination pair i₁ and relay k₁, in step 405, the controller 104 assigns relay k₁ to the source-destination pair i₁, wherein the selected Q-value corresponds to the source-destination pair i and relay k₁. In step 406, the controller 104 removes the selected source-destination pair and relay and all their corresponding Q-values from further consideration. The number of remaining Q-values is: (M−l)×(N−l), where l is the number of relays removed from consideration so far. In step 407, the controller 104 selects the highest Q-value from the remaining (M−l)×(N−l) Q-values. If the selected Q-value corresponds to source-destination pair i₁ and relay k, in step 408, the controller 104 assigns relay k to source-destination pair i. The controller 104 repeats the above steps until every source-destination pair has a relay assigned to it (as per the check in step 409). In step 410, the controller 104 updates the Q-values of each source-destination pair using equation (1) and stores the updated Q-values in the respective Q-tables. In step 411, each source communicates with its corresponding destination via the relay assigned to the respective source-destination pair. The various actions in method 400 may be performed in the order presented, in a different order or simultaneously. Further, in some embodiments, some actions listed in FIGS. 4A and 4B may be omitted.

The embodiments disclosed herein can be implemented through at least one software program running on at least one hardware device and performing network management functions to control the network elements. The network elements include blocks which can be at least one of a hardware device, or a combination of hardware device and software module.

The embodiment disclosed herein describes systems and methods for relay selection in mmWave networks. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

We claim:

1. A method for selecting a relay in millimeter wave (mmWave) networks, the method comprises:
computing, by a controller, a first Signal to Noise Ratio (SNR) from at least one source to at least one relay, and a second SNR from the at least one relay to at least one destination;
selecting, by the controller, a relay with a highest Q-value for enabling communication between the at least one source and the at least one destination, if a randomly selected number is more than ϵ;
selecting, by the controller, a relay randomly for enabling communication between the at least one source and the at least one destination, if the randomly selected number is not more than ϵ; and
communicating, by the at least one source, with the at least one destination via the selected relay.

2. The method, as claimed in claim 1, wherein the method further comprises:
selecting, by the controller, a highest Q-value from remaining Q-values, wherein Q-values of the selected relay for enabling communication between the at least one source and the at least one destination is not considered, till all of the at least one source and the at least one destination have a relay assigned to them.

3. The method, as claimed in claims 1, wherein the method further comprises:
receiving, by the controller, a reward;
updating, by the controller, the Q-value using a Bellman equation; and
storing, by the controller, the updated Q-value in a Q-table.

4. A controller for selecting a relay in millimeter wave (mmWave) networks, the controller configured for:
computing a first Signal to Noise Ratio (SNR) from at least one source to at least one relay, and a second SNR from the at least one relay to at least one destination;
selecting a relay with a highest Q-value for enabling communication between the at least one source and the at least one destination, if a randomly selected number is more than ϵ, wherein the at least one source can communicate with the at least one destination via the selected relay; and
selecting a relay randomly for enabling communication between the at least one source and the at least one destination, if the randomly selected number is not more than ϵ, wherein the at least one source can communicate with the at least one destination via the selected relay.

5. The controller, as claimed in claim 4, wherein the controller is further configured for:
selecting a highest Q-value from remaining Q-values, wherein Q-values of the selected relay for enabling communication between the at least one source and the at least one destination is not considered, till all of the at least one source and the at least one destination have a relay assigned to them.

6. The controller, as claimed in claim 4, wherein the controller is further configured for:
receiving a reward;
updating the Q-value using a Bellman equation; and
storing the updated Q-value in a Q-table.
